(19) United States
(12) Patent Application Publication
(10) Pub. No.: US 2007/0079791 A1
(43) Pub. Date: Apr. 12, 2007

(54) WaveTech engine

(76) Inventor: Bradley Raether, Redmond, OR (US)

Correspondence Address: Brad Raether, Suite 105-307, 944 SW Veterans Way, Redmond, OR, 97756, US

(21) Appl. No.: 11/544,817

(22) Filed: Oct. 7, 2006

Related U.S. Application Data
(60) Provisional application No. 60/724,390, filed on Oct. 7, 2005.

(51) Int. Cl. F02B 75/32; F02B 75/20

(52) U.S. Cl. 123/197.1; 123/58.1

(57) ABSTRACT

Reciprocating engine construction wherein a rotating assembly converts the linear motion of the piston into rotational motion more efficiently, therefore yielding more torque and working power while using less fuel. The rotating assembly is three components working together, an interchanger unit with track rollers mounted at both ends and attached at it's center to the connecting rod by bearings allowing it to rotate while reciprocating, a stationary cylindrical unit having opposing wave shaped races (tracks) encircling it's perimeter with slopes of at least 45 degrees to convert the reciprocating motion to rotational motion on a one to one ratio 90 degrees perpendicular to the axis of the interchanger as the track rollers follow the slopes of the races, a rotating carrier that keeps the track rollers aligned and transfers the converted rotational motion to the output shaft by means of gears.

This application concerns improvements in reciprocating engines of spark ignition, compression ignition, or other means of providing pressure to the piston and in particular concerns novel configuration of and physical relationship between the piston and output shaft (crankshaft) through a rotating assembly that more efficiently converts the linear motion of the piston to circular motion, therefore yielding an increased amount of working power from less fuel.

### BACKGROUND OF THE INVENTION

Reciprocating engines have long been known and widely used. Reciprocating engines using internal combustion cycles of various types go back to before the turn of the last century. Today the most common form of reciprocating engines is the internal combustion engine also often known as a piston engine that uses one or more pistons to convert pressure into a rotating motion. Today most reciprocating engines use one of three types of internal combustion cycles, the Otto cycle (four stroke cycle), Diesel cycle or two stroke cycle which uses the combustion of petrol, alcohol, diesel fuel, oil or gaseous type fuels inside the cylinder to provide pressure to the pistons. Reciprocating engines that are powered by pressurized fluid, compressed air, steam or other hot gasses are also still used in some applications today. Though reciprocating engines have achieved considerable popularity and commercial success, there has been a continuing need to increase the efficiency of engines to produce more working power from less fuel.

### SUMMARY OF THE INVENTION

### Wavetech Engine

The invention may, in its broad sense, be defined as improvements in a reciprocating engine having a block forming a housing for a piston operating in a cylinder (or multiple pistons in cylinders), a rotating assembly for each piston to more efficiently convert the linear motion of the piston(s) into rotational motion to an output shaft (crankshaft) utilizing gears instead of throws, a lubrication system, a head (or multiple heads) forming the top of the combustion chamber(s) and a housing for automotive style intake and exhaust valves as part of a fuel delivery and exhaust system and spark plugs controlled by a spark ignition system or glow plugs in a diesel cycle engine. The improved structure concerns a novel design for a rotating assembly composed of three components cooperating together, an interchanger unit that reciprocates with the piston and rotates at the same time, a cylindrical unit mounted stationary to the engine block having opposing wave shaped races (tracks) encircling it's perimeter for the track rollers of the interchanger unit to follow and a carrier that rotates with the interchanger that keeps the track rollers aligned on the races and transfers the converted rotational motion to the output shaft by means of gears. The carrier also includes a mechanical means of absorbing the energy at the end of each stroke created by inertia as the speed (RPM's) of the engine increases, then releasing that energy back after the track rollers pass the upper and lower radiuses of the races, therefore helping facilitate the reciprocating motion of the piston, connecting rod and interchanger unit for the purpose of increasing the performance, service life and dependability of the engine by reducing stress to the track rollers, interchanger unit and races. The rotating assembly and geared crankshaft configuration is to convert the linear motion of the piston into a greater amount of rotational working power to the crankshaft utilizing an increased leverage angle for a much longer duration of the combustion stroke than with a standard automotive style connecting rod and crankshaft configuration while keeping the rest of the engines design and functions the same or close to the same as the well known and proven combustion engine technology of today.

The invention is illustrated by the accompanying drawings which form a part of this specification, in which:

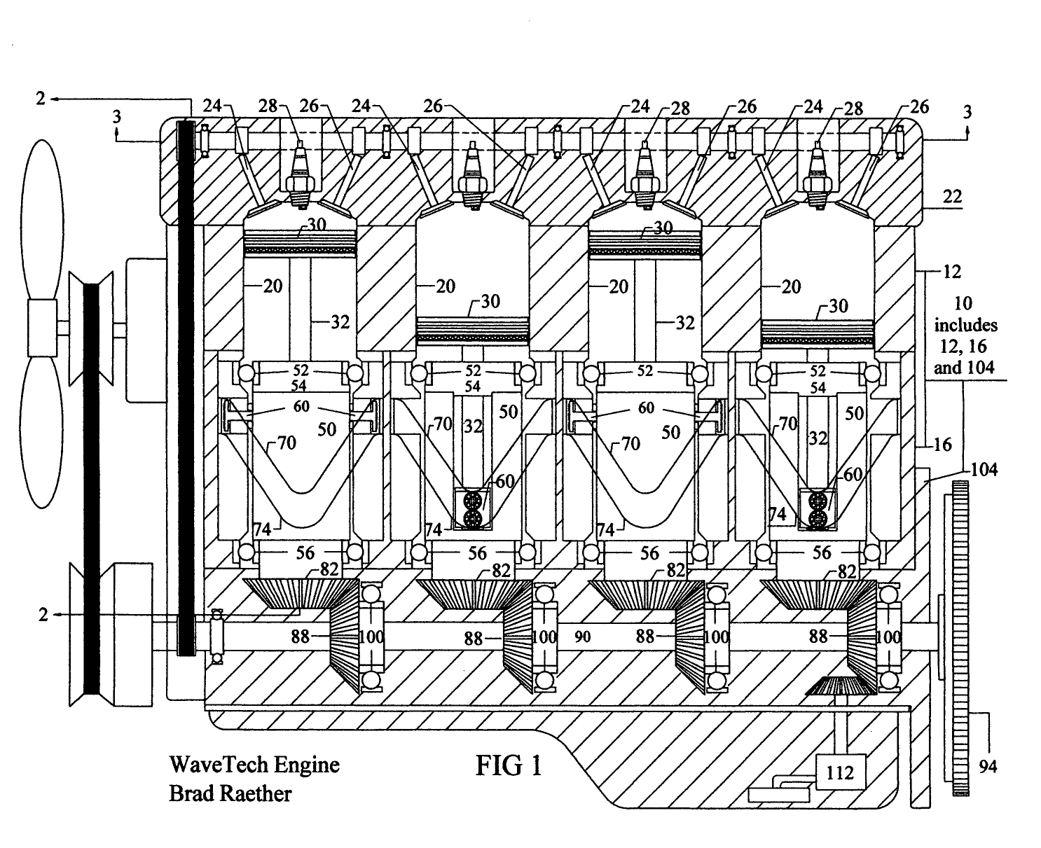

FIG. 1 is a cutaway side view of an engine of a four-cylinder internal combustion configuration with some parts deleted for clarity of illustration;

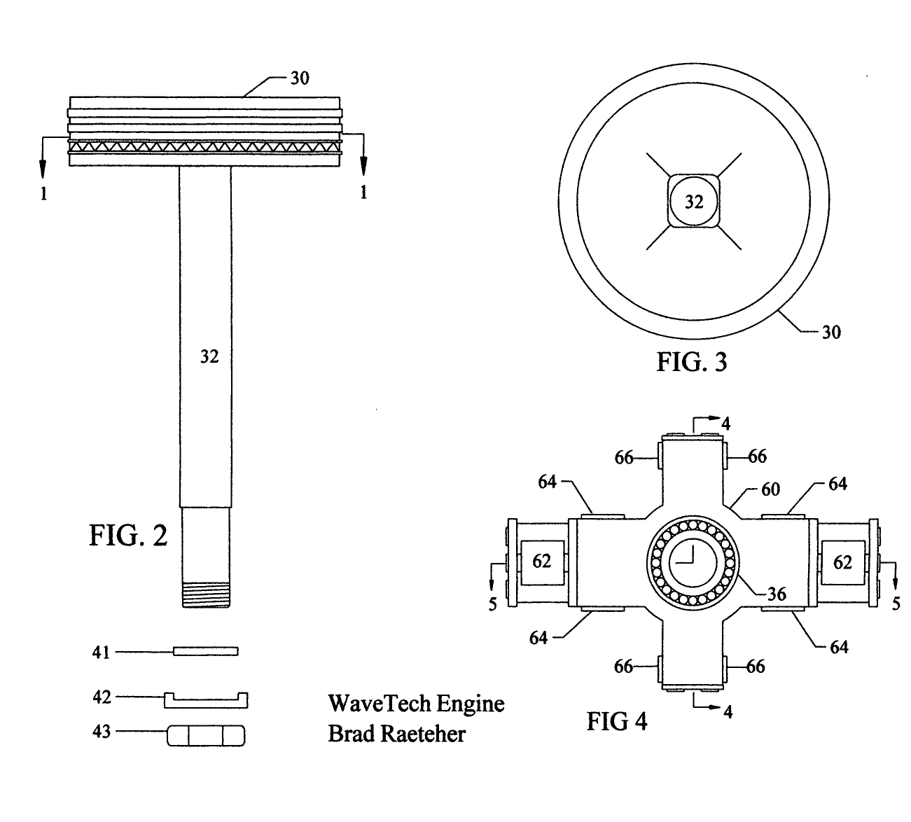

FIG. 2 is a view of a piston, connecting rod, retaining nut and washers. The connecting rod and piston are one solid piece or two pieces securely fastened together;

FIG. 3 is a view of a connecting rod and piston taken along 1-1 of FIG. 2;

FIG. 4 is a top view of the interchanger unit;

FIG. 5 is an end view of the interchanger unit taken along 4-4 of FIG. 4;

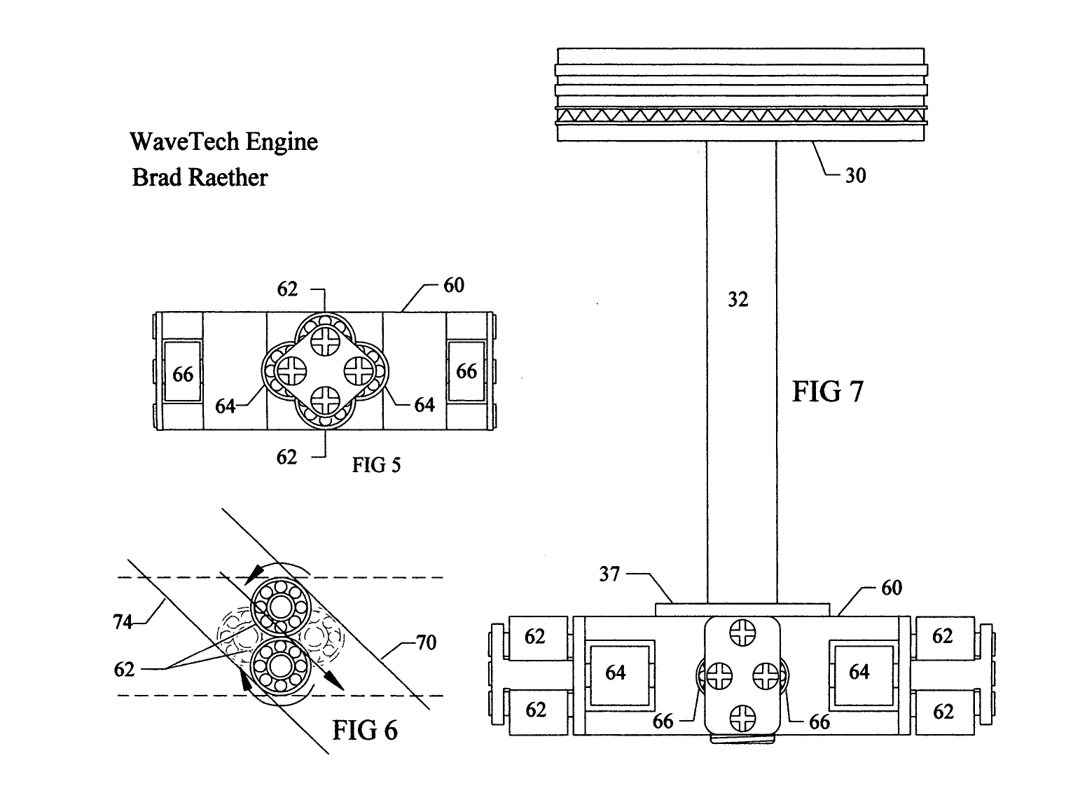

FIG. 6 is a view of the track rollers exposed to show them in contact with each other and direction of rotation as they ride between the races;

FIG. 7 is a side view of the interchanger unit taken along 5-5 of FIG. 4 shown attached to a connecting rod and piston;

FIG. 8 is a an exploded view of all the parts included in fastening the interchanger to a connecting rod;

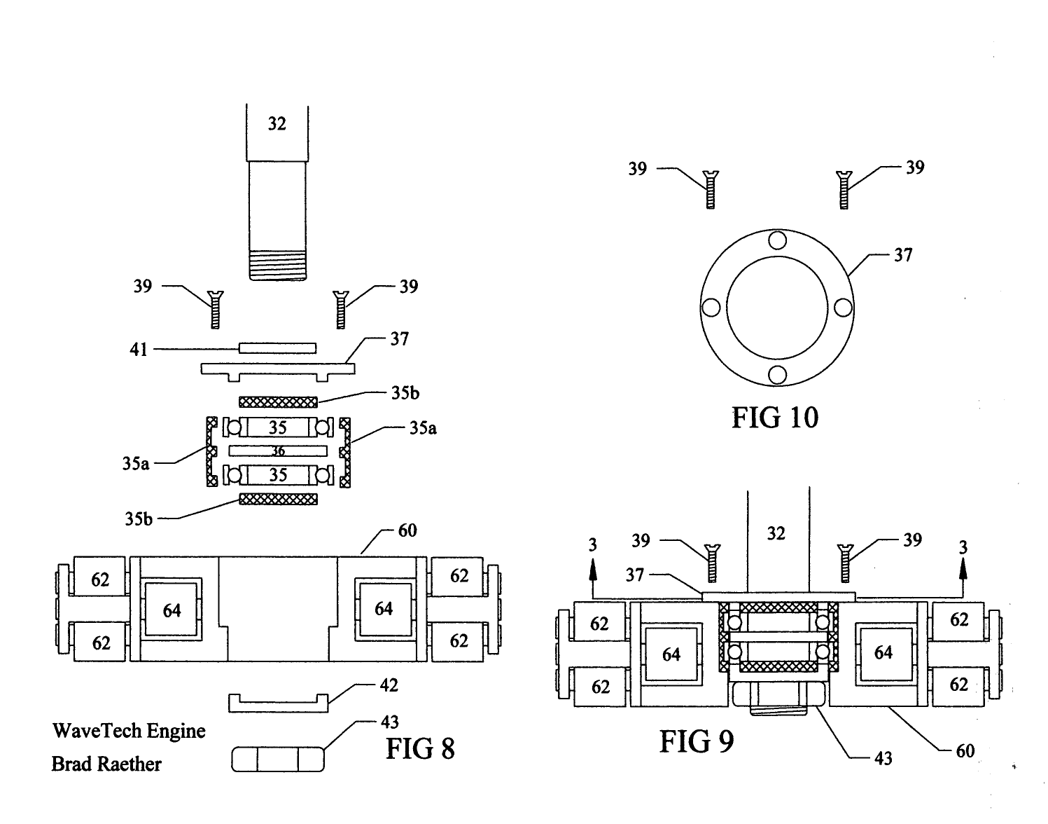

FIG. 9 is a cutaway view of the interchanger unit fastened to a connecting rod to show correct location of all parts as installed;

FIG. 10 is a view of the thrust-bearing retainer as taken along 3-3 of FIG. 9, and screws;

FIG. 11 is a side view of the rotating carrier unit assembled.

FIG. 12 is a view of the upper carrier bearing support as taken along 4-4 of FIG. 11;

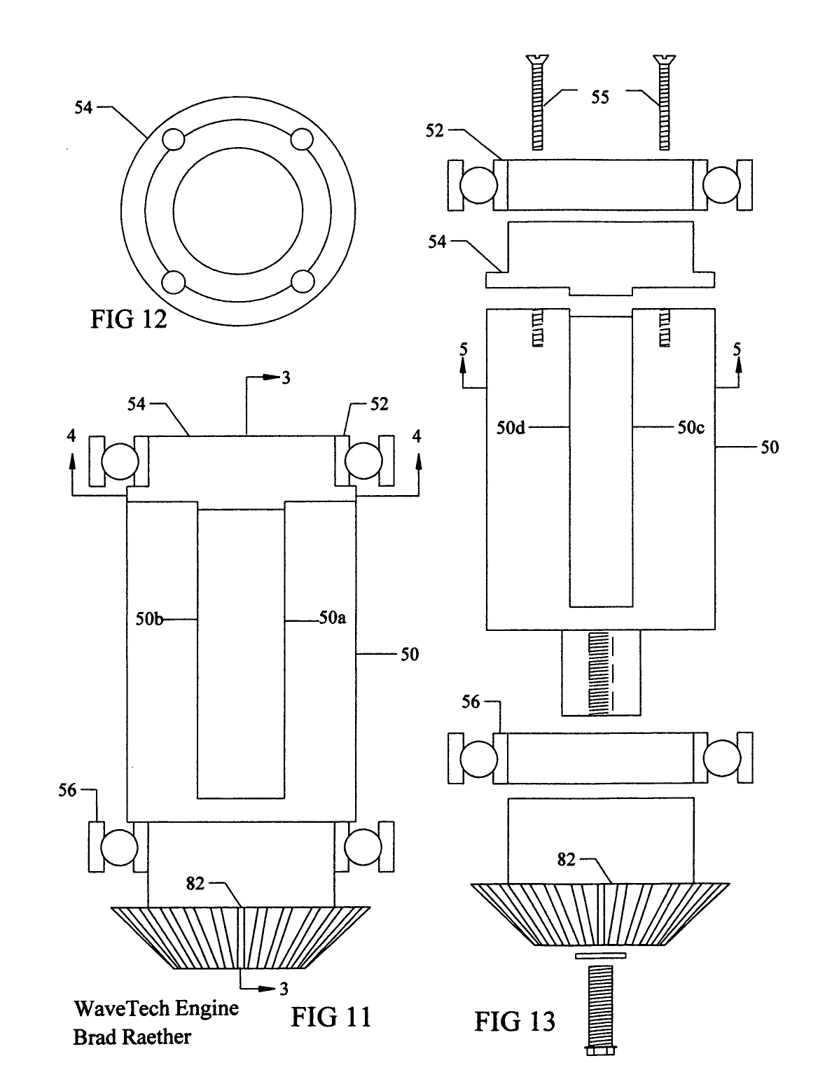

FIG. 13 is an exploded view of the rotating carrier taken along 3-3 of FIG. 11, to show all parts including the driver gear attached to it's lower end that transfers converted rotational motion to the crankshaft via a matching driven gear on the crankshaft;

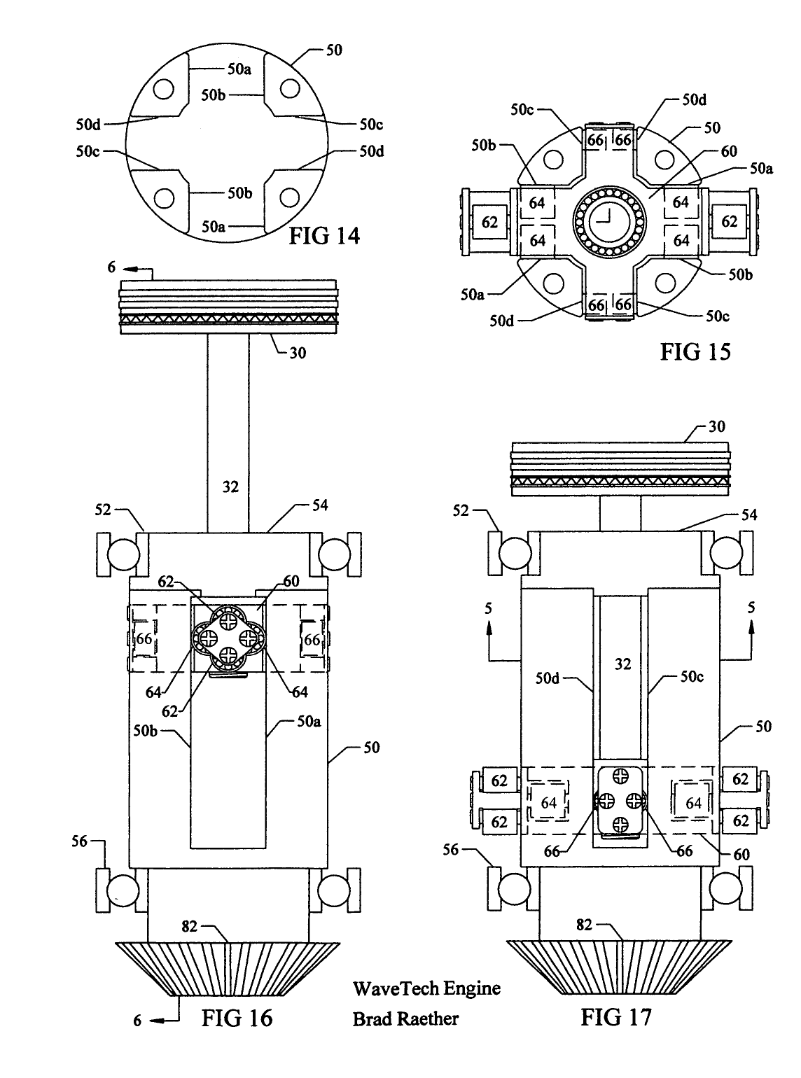

FIG. 14 is a view of the rotating carrier taken along 4-4 of FIG. 11, to show individual lettering of the tracks that the power transfer rollers and interchanger centering rollers ride on;

FIG. 15 is the same as FIG. 14, except rotated 90 degrees, with the interchanger sitting in it to show correct positioning;

FIG. 16 is a view of the assembled rotating carrier with a piston, connecting rod and interchanger sitting in it to show correct position in an extended position;

FIG. 17 is the same as FIG. 16 taken along 6-6 of FIG. 16 to show correct position of the piston, connecting rod and interchanger in a compressed position;

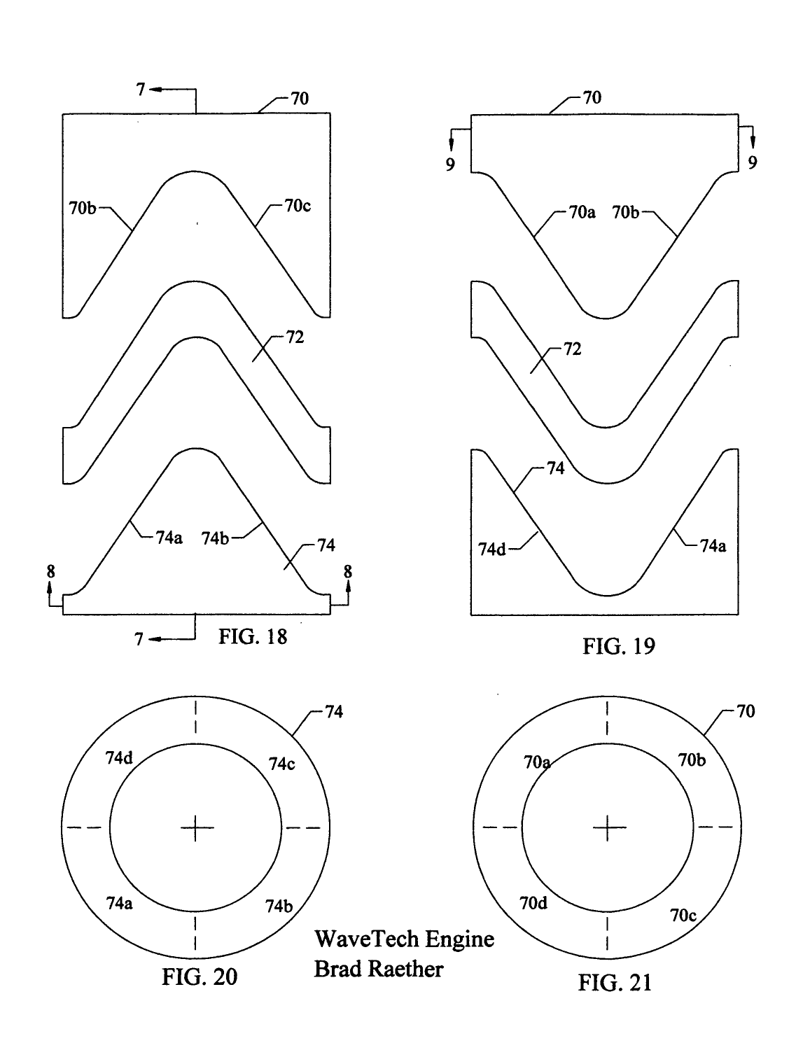

FIG. 18 is an exploded view of the upper and lower wave races showing the individually numbered slopes of the races and the spacer;

FIG. 19 is the same as FIG. 18 taken along 7-7 of FIG. 18;

FIG. 20 is a view of the lower wave race as taken along 8-8 of FIG. 18;

FIG. 21 is a view of the upper wave race as taken along 9-9 of FIG. 19;

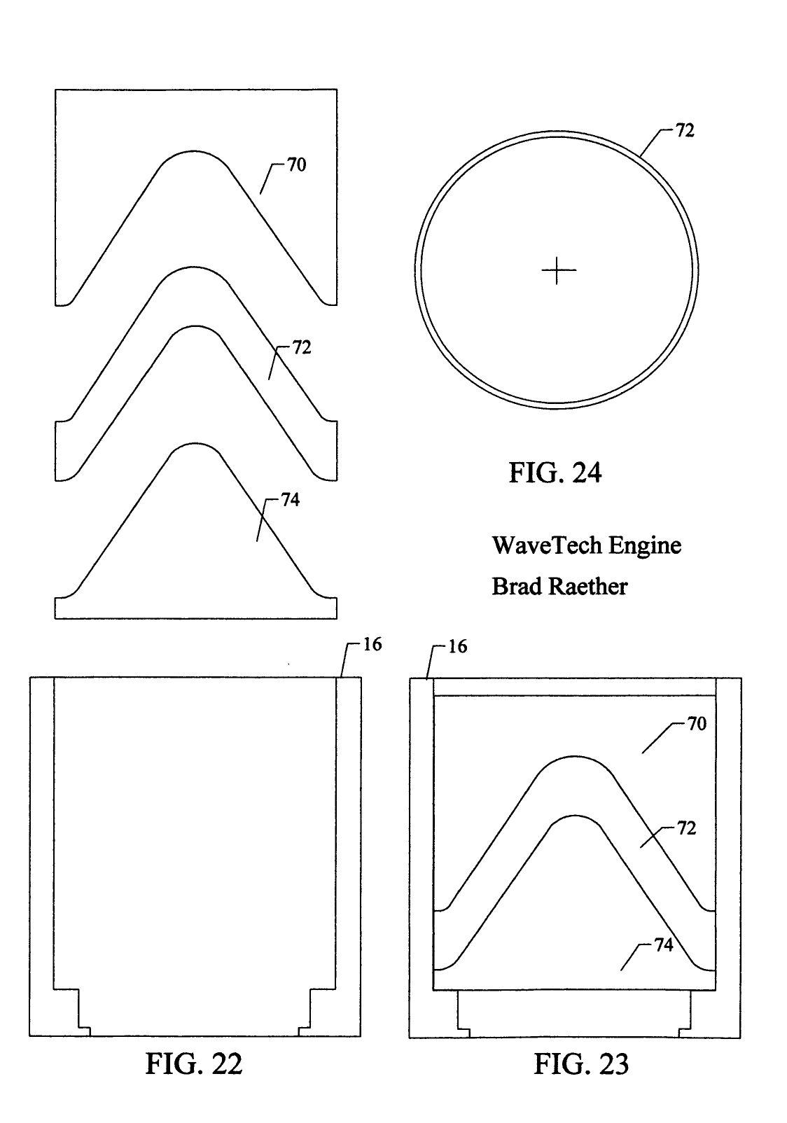

FIG. 22 is an exploded view of the interchanger block, wave races and spacer;

FIG. 23 is a view of the interchanger block, wave races and spacer assembled as a unit;

FIG. 24 is a view of the wave race spacer as taken along 8-8 of FIG. 18;

FIG. 25 is view of the lower wave race as taken along 8-8 of FIG. 18 with the interchanger sitting on it to show correct positioning;

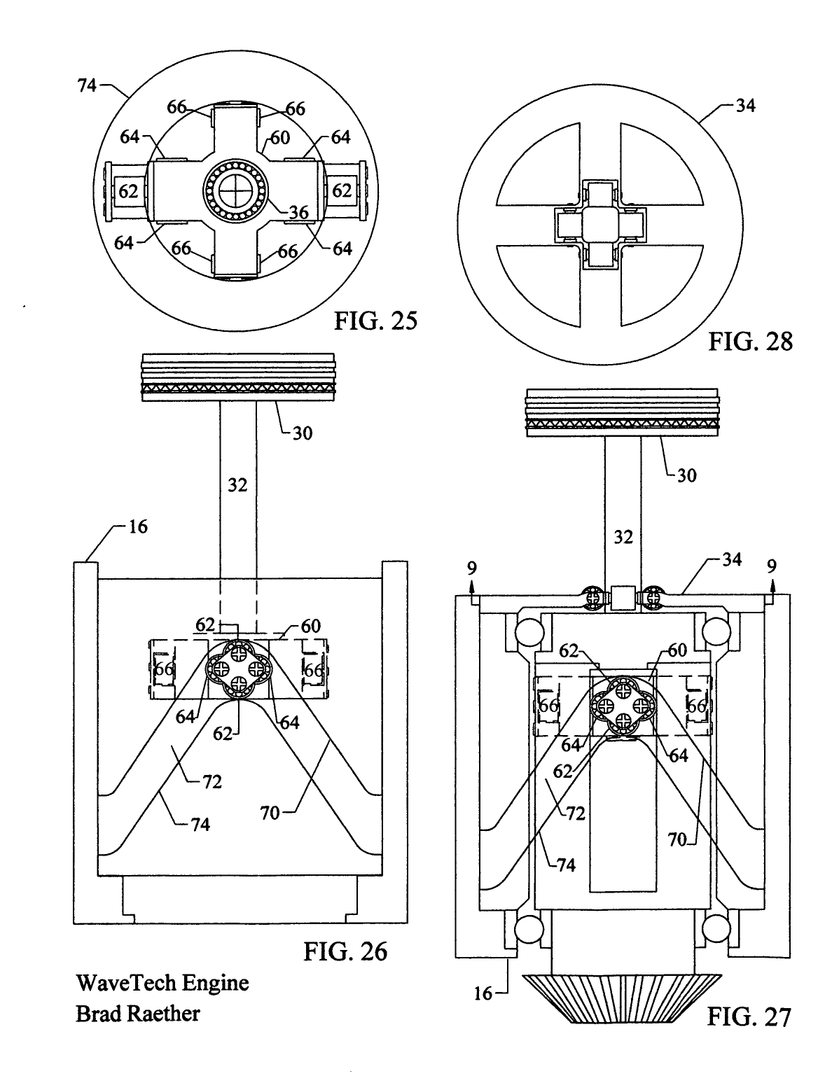

FIG. 26 is the same as FIG. 23 with the interchanger, piston and connecting rod extended to show correct positioning;

FIG. 27 is the same as FIG. 26 with the rotating carrier and connecting rod stabilizer also installed to show correct positioning and is shown as a complete rotating assembly;

FIG. 28 is a view of the connecting rod stabilizer unit as taken along 9-9 of FIG. 27;

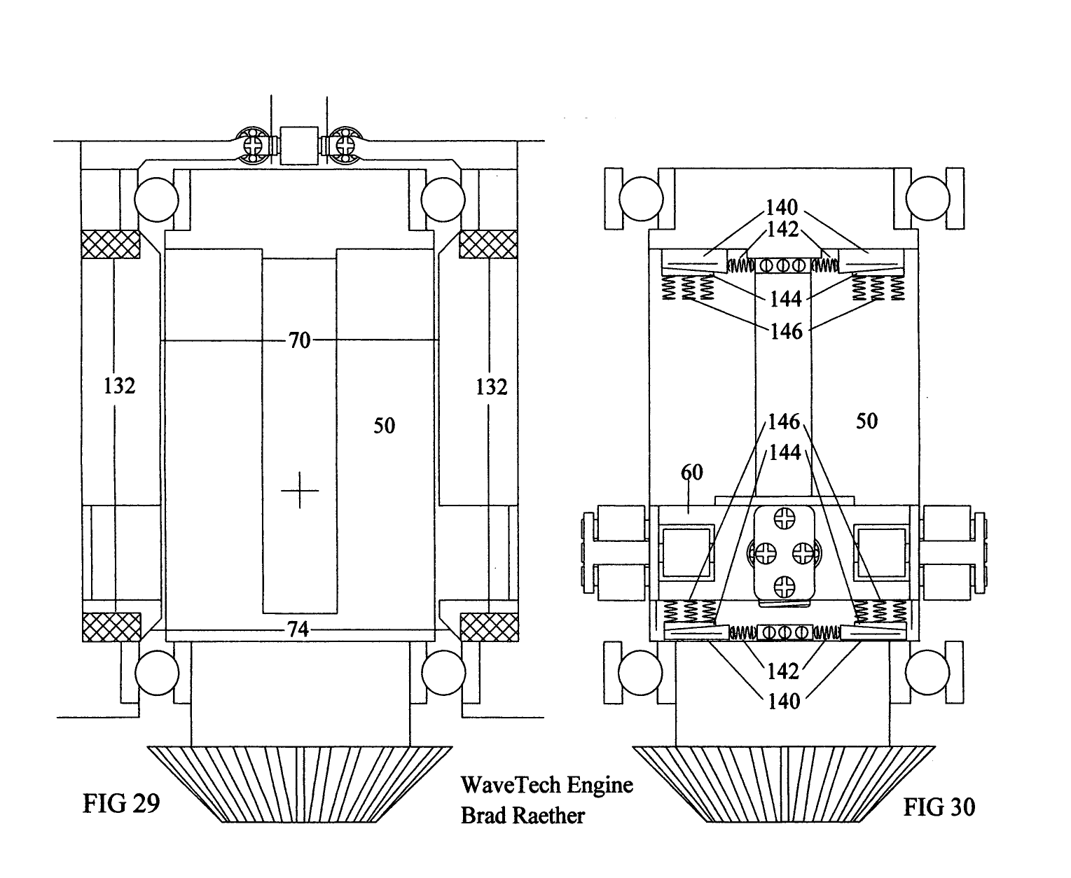

FIG. 29 is a view of a rotating assembly with some parts deleted for clarity of illustration, showing the wave races mounted on shock absorbing pads.

FIG. 30 is a view of a rotating carrier and interchanger unit with some parts deleted for clarity of illustration, showing a reciprocator system installed in the carrier.

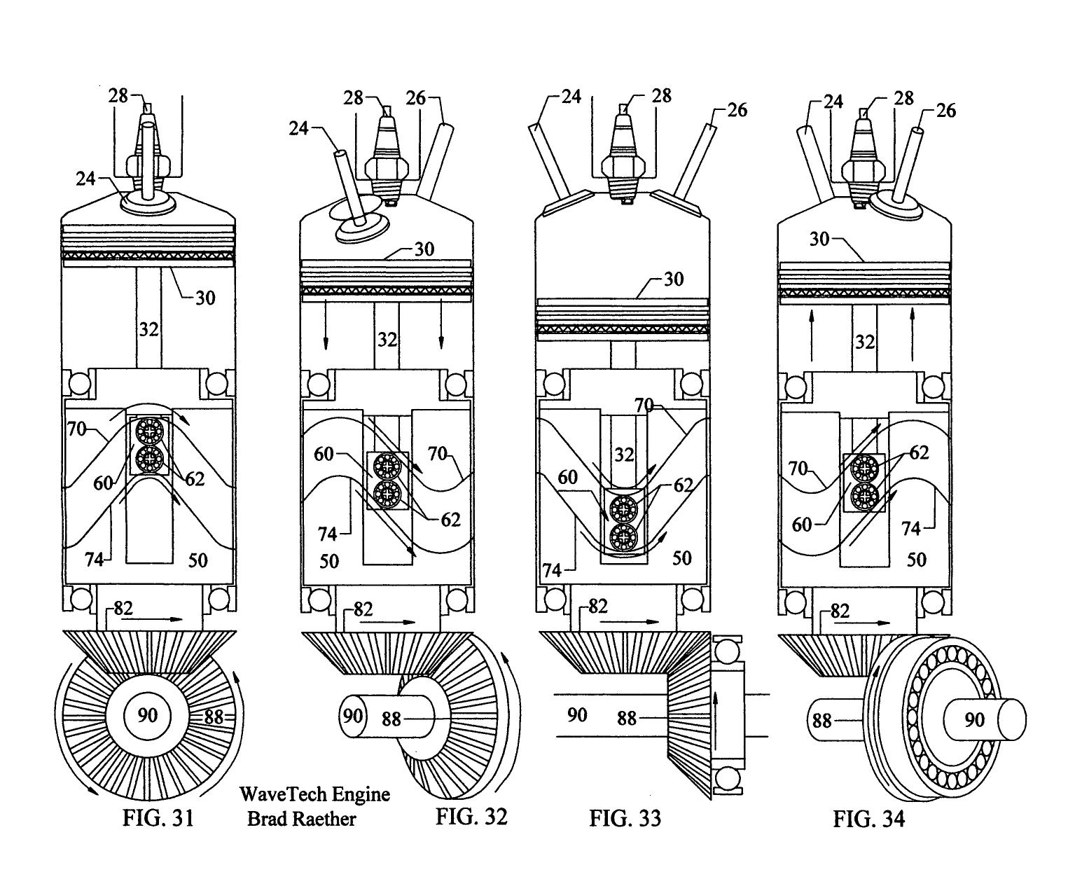

FIG. 31 is a view of a complete rotating assembly as installed in an engine as taken along 2-2 of FIG. 1 with some parts deleted for clarity of illustration, the piston and valves are shown ready to start an intake stroke;

FIG. 32 is the same as FIG. 31 except rotated one eighth of a turn to the right with the intake valve open, the piston halfway into an intake stroke and the interchanger unit rotating counter clockwise as viewed from above;

FIG. 33 is the same as FIG. 32 except rotated one eighth of a turn to the right with the intake valve closed and the piston at the end of the intake stroke and ready to start the compression stroke;

FIG. 34 is the same as FIG. 33 except rotated one eighth of a turn to the right with the piston halfway into the compression stroke;

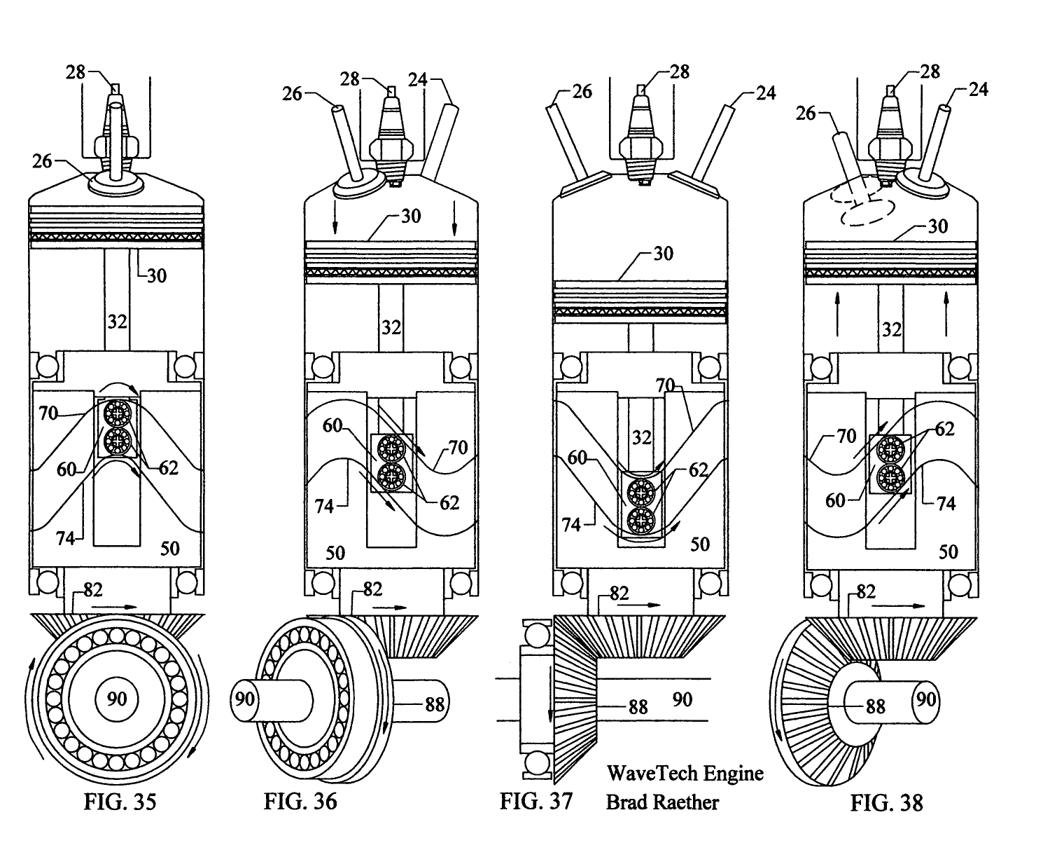

FIG. 35 is the same as FIG. 34 except rotated one eighth of a turn to the right with the piston at the end of the compression stroke and ready to start the combustion stroke;

FIG. 36 is the same as FIG. 35 except rotated one eighth of a turn to the right with the piston halfway into the compression stroke;

FIG. 37 is the same as FIG. 36 except rotated one eighth of a turn to the right with the piston at the end of the combustion stroke and ready to start the exhaust stroke;

FIG. 38 is the same as FIG. 37 except rotated one eighth of a turn to the right with the exhaust valve open and the piston halfway into the exhaust stroke. The next position for the piston to be in will be the same as FIG. 31 ready to start the four cycles over.

### DETAILED DESCRIPTION OF THE INVENTION

Referring to the drawings, the engine comprises a block 10, which is composed of a cylinder block 12, interchanger block 16, and crankcase 104, having bores defined by cylinders 20, cylinder head 22, intake means 24, ignition means 28, exhaust means 26, pistons 30, wave races 70 (upper) and 74 (lower), Interchanger units 60, rotating carriers 50, driver and driven gears 82 and 88, crankshaft 90, lubrication means 112 and various working and support bearings 52, 56 and 100.

In the particularly advantageous embodiment of the invention illustrated, the rotating assembly as shown in FIG. 27, is composed of three main components functioning together, an interchanger unit 60, as shown in FIGS. 4, 5, and 7, having track rollers 62, which ride between two wave shaped races 70 and 74 that are parts of a stationary mounted cylindrical unit as shown in FIG. 23. The third component is a rotating carrier unit 50, mounted on bearings 52 and 56, with the top bearing 52, mounted on a support 54, that also adds stability to the carrier, as shown in FIG. 11, in which the interchanger 60 rides up and down in to keep the interchanger 60, centered by means of centering rollers 66, riding on the carrier tracks 50c and 50d as seen in FIGS. 13, 14 and 15, to maintain correct orientation of the track rollers 62, on the races 70 and 74. The carrier 50, also transfers the converted rotational motion from the interchanger 60, by means of the power transfer rollers 64, riding on the carrier tracks 50a and 50b as shown in FIGS. 11, 14 and 15, to the output shaft (crankshaft) 90, via gears 82 and 88 as shown in FIGS. 1, 11, 13, 27 and 31 through 38, Referring to FIGS. 31 through 38, are illustrations of the engine through the four cycles of an Otto cycle or Diesel cycle engine from beginning to end starting with the piston 30, ready to begin the intake cycle, then continuing through the compression cycle, combustion cycle and ending with the exhaust cycle. In FIGS. 31 through 38 it shows the movement of the track rollers 62 as they traverse up and down the slopes 74a, 74b, 74c, 74d and 70a, 70b, 70c, 70c of the wave races 74 and 70, as also shown in FIGS. 18, 19, 20 and 21.

The interchanger 60, is so named because it converts reciprocating motion into rotational motion during the combustion cycle and then converts rotational motion to reciprocating motion during the intake, compression and exhaust cycles. The conversion from reciprocating motion to rotational motion is accomplished during the combustion stroke when the rollers 62, are forced at the same time down the declining slopes 1b and 2b, as shown in FIG. 21, causing a downward spiraling motion. Because the faces of the slopes 2b, and 2b are of a 45 degree decline (after a short radius at the top), the downward pressure from the piston 30, is converted to rotational motion at a one to one ratio. This means that for every inch the piston 30, moves down, the interchanger will rotate an inch therefore converting the reciprocating motion of the piston 30, into rotational motion at a 90 degree angle to the axis of the interchanger and therefore achieve an optimal transfer of energy. The rotating carrier as seen in FIG. 12 then transfers the converted rotational motion to the crankshaft 90, through the driver and driven gears 82 and 88, when the power transfer rollers 64, and interchange centering rollers 66, as seen in FIGS. 6, 7 and 8, ride up and down the races 50a, 50b, 50c and 50d, of the carrier 50, while under the pressure created by the interchanger 60, as they follow the contours of the races 70 and 74.

The piston 30, is returned to the cylinder top (Top dead center) and through the remaining three strokes of the combustion cycle either by centrifugal force from the flywheel 94, as seen in FIG. 1, attached to the crankshaft 90, or the power from other pistons connected to the same crankshaft 90. A flywheel 94 is also used to ensure smooth rotation.

To help insure the performance and service life of the engine, the piston 30, is held from spinning inside the cylinder 20, by means of a stabilizer unit 34, as seen in FIGS. 27 and 28. The stabilizer unit 34, keeps the piston from spinning by means of four rollers that stay in contact with the four sides of the connecting rod 32, as shown in FIGS. 2 and 3. The piston 30, and connecting rod 32, are able to be restrained from spinning because they are attached to the interchanger 60, by means of thrust bearings 35, as seen in FIGS. 8 and 9. Also referring to FIGS. 2, 8, and 9, the retaining nut 43, and washers 41 and 42, thrust bearing retainer 37, and screws 39, as seen in FIGS. 9 and 10, also retain shock dampeners 35a and 35b, that help shield the thrust bearings 35, from shock created from combustion to the piston 30, or inertia during higher speeds of the engine as the track rollers 62, reach the top and bottom radiuses of the races 70 and 74

Referring to FIG. 6, the track rollers are mounted in such a manner as to keep them in contact with each other. This contact is for the purpose of keeping them always spinning at the correct speed and direction as they ride on the races 70 and 74. The spacer 72, as seen in FIGS. 23 and 24 keeps the races 70 and 74, at the correct distance from each other to maintain close tolerance to the track rollers 62, but as the track rollers 62, follow the contours of the races 70 and 74, contact will fluctuate between the races, so to keep the track rollers 62, from skidding on the races or have to change in rotational direction, they are always kept spinning the correct direction and speed by always being in contact with the other roller. The track rollers 62, always being in contact with each other also allows the load subjected to one roller to be shared by both, therefore reducing the load that any one roller will have to bear on its own which will extend the service life of both rollers. The track rollers 62, and races 70 and 74 may be substituted for other means of accomplishing the same functions such as magnets, hydraulics, pressurized air or any other means that will facilitate a similar type working relationship that will yield the same results, The rotating assembly may also be configured to where the interchanger and carrier are mounted stationary with the races rotating around them or any other configuration that yields the same results.

Referring to FIG. 29, the races 70 and 74, are shown mounted on shock absorbing dampeners 132. These dampeners are installed to absorb and release shock created from combustion to the piston 30, or inertia during higher speeds of the engine as the track rollers 62, reach the top and bottom radiuses of the races 70 and 74. These dampeners 132, may be made of high density rubber or polyurethane type materials that offer a higher load-bearing capacity than rubber with more resistance to oils and chemicals found on the inside of an engine. This same rubber or polyurethane type materials will also be used in the shock dampeners 35a and 35b as seen in FIG. 8. Springs, conical washers, fluid, air or any other means may be substituted for the rubber or polyurethane dampeners 35a, 35b and 132.

Referring to FIG. 30, a reciprocator system is shown installed in the carrier 50, which is operated by centrifugal force. As the speed (RPM's) of the engine increases, the inclined centrifugal weights 140, overcome the resistance of the centrifugal weight springs 142, allowing the weights to move outward from the center of the carrier 50. The resulting movement causes the reciprocator spring inclines 144, to move up creating more pressure on the reciprocator springs 146, therefore creating a speed sensitive mechanical means of absorbing the increasing amount of energy at the end of each stroke created by inertia as the speed (RPM's) of the engine increases, then releasing that energy back after the track rollers 62, pass the upper and lower radiuses of the races 70 and 74, therefore helping facilitate the reciprocating motion of the piston 30, connecting rod 32, and interchanger unit 60, for the purpose of increasing the performance, service life and dependability of the engine by reducing stress to the track rollers 62, interchanger unit 60, and races 70 and 74. This mechanical reciprocator system may be substituted for a different type of system that utilizes pressurized fluids, compressed air, magnets or other means to accomplish the same speed sensitive absorbing and releasing of energy process.

The materials to be used in the overall construction of the engine is expected to be aluminum, steel, rubber, plastics, automotive type gaskets and most any other materials commonly used in the manufacture of engines. Some exotic materials such as ceramics or specialty metals may be used in key areas such as the combustion chambers, rotating assemblies etc. The materials to be used in the rotating assembly will generally be of high-grade steel or similar materials because they are subjected to high pressures and impact. A softer surface may be applied to the tracks 70 and 74, such as high-density rubber or polyurethane type materials to help reduce shock loads to the track rollers 62.

Many other parts and functions of this engine and overall construction were not discussed in detail or discussed very little in this description due to the nature of many parts, designs, functions and construction of this engine do not differ or differ very little from designs, and technology already well known and used for many years and therefore considered common knowledge and standard practice in the field of reciprocating engines. Some of these functions include but are not limited to; fuel delivery system, lubrication means, ignition system, cooling system, compression ratios, combustion chamber sealing, high performance modifications, supercharging, turbocharging, previous designs, manufacturing procedures, materials of manufacture, maintenance, means for attaching this engine to machinery or transmission etc. By remaining close to the current engine designs, materials of manufacture and manufacturing procedures of today allows this engine to be reproduced more readily and also makes it much easier for consumers to understand, maintain and operate by being nearly the same as the engines they are already familiar with.

The invention has been described in detail with particular reference to the embodiments thereof, but it will be understood that variations and modifications can be affected within the spirit and scope of the invention.

The embodiments of the invention in which an exclusive property or privilege is claimed are defined as follows:

1. In a reciprocating engine having a block forming a housing for a piston operating in a cylinder (or multiple pistons in cylinders), wherein a rotating assembly for each piston converts the linear motion of the piston into rotational motion. The rotating assembly is composed of three components cooperating together, an interchanger unit with track rollers mounted at both ends and attached at it's center to the connecting rod by bearings allowing it to rotate while reciprocating, a stationary cylindrical unit having opposing wave shaped races (tracks) encircling it's perimeter with slopes of at least 45 degrees for the track rollers of the interchanger to follow as to facilitate an up and down spiraling motion therefore converting the reciprocating motion of the piston into rotational motion while allowing the interchanger to continue rotating in the same direction. The third component of the rotating assembly is a rotating carrier supported by bearings that supports the interchanger while rotating with the interchanger, keeps the track rollers of the interchanger aligned and transfers the converted rotational motion to the output shaft by means of gears. These same three components working in cooperation with each other also facilitates the piston through the remaining strokes or cycles from energy provided by centrifugal force from the flywheel or the power from other pistons connected to the same crankshaft working in reverse of the above mentioned process as the complete rotating assembly continues to rotate in the same direction.

2. The combination defmed in claim 1, wherein the 45-degree angle of the slopes of the races can be increased or decreased by varying degrees to yield different torque and outputs.

3. The combination defmed in claim 1, wherein the 45-degree angle of the decline slopes of the races can be preset with a steadily increasing decline to yield a level or more level torque output to compensate for decreasing combustion pressures.

4. The combination defmed in claim 1, wherein by adding additional waves of different heights between the original wave races will allow preset different lengths of compression strokes to combustion strokes.

5. The combination defmed in claim 1, wherein by moving the wave races closer or farther away from the cylinder heads manually or automatically through a speed sensitive mechanism, the compression ratio can be adjusted on the fly to meet different requirements such as different types of fuels, different elevations, increased power and performance needs etc.

6. The combination defined in claim 1, wherein variable ratios between driver and driven gears will yield different output shaft speeds to allow for drive shafts, propellers or any other driven item to run at different speeds than the engine's speed without separate gear or pulley increase or reduction ratio or transmission. etc.

7. The combination defined in claim 1, wherein any other source of reciprocating motion can be attached to the rotating assembly instead of a piston to yield rotational motion. Several examples could be electric powered solenoids, bicycle pedals, magnet-powered piston, artificial muscle etc.

8. The combination defmed in claim 1, wherein the driver gear or main shaft of the carrier can be used as a camshaft or drive the camshaft because of the correct ratio between the piston and the carrier to operate a standard valvetrain.

9. The combination defmed in claim 1, wherein the crankcase could also be a transmission housing combined by mating up the gears of the transmission to the driver or driven gears of the engine.

10. The combination defmed in claim 1, wherein with a different valve system the engine can be configured as a steam, compressed air or hot gasses engine or pump or hydraulic or pneumatic engine etc.

11. The combination defmed in claim 10, wherein as a steam, pneumatic, hydraulic, engine or pump utilizing any constant pressure will yield constant torque and output with a 45 degree angle or any other constant angle of races from near very beginning of stroke to very near end of stroke.

12. The combination defined in claim 1, wherein by mounting the track rollers in constant contact with each other allows contact with upper and lower tracks at same time and allows both rollers to share the work load even when only one is in contact with a race. Rollers mounted in this manner allows them to always be turning the correct direction to the race and handle heavier loads at critical areas and times such as the radiuses and combustion cycle.

13. The combination defined in claim 1, wherein a system that absorbs the increased energy from inertia at the radiuses of the wave races, then releasing that energy back after the track rollers pass the upper and lower radiuses of the races allows for higher RPM's and makes the engine much more durable and allows 45 degree and steeper inclines and declines of the races to allow for the greatest conversion of linear motion to rotational power and extend the life of the engine and reduce vibration and other power robbing conditions.

14. The combination defined in claim 1, wherein double opposing races and rollers utilized with a single piston allows for more even loads, bigger loads, no side loading on pistons, steeper races and keeps the interchanger more easily centered.
